(19) United States
(12) Patent Application Publication
(10) Pub. No.: US 2003/0142954 A1
(43) Pub. Date: Jul. 31, 2003

(54) Moving image reproduction description method, moving image reproduction recording apparatus, storage medium and control program

(76) Inventors: Takuya Kotani, Kanagawa (JP); Yoshiki Ishii, Kanagawa (JP); Masanori Ito, Osaka (JP); Masafumi Shimotashiro, Osaka (JP); Tadashi Nakamura, Nara (JP); Makoto Mitsuda, Osaka (JP)

Correspondence Address: FITZPATRICK CELLA HARPER & SCINTO, 30 ROCKEFELLER PLAZA, NEW YORK, NY, 10112, US

(21) Appl. No.: 10/191,487

(22) Filed: Jul. 10, 2002

(30) Foreign Application Priority Data
Jul. 13, 2001 (JP) 214317/2001(PAT.)

(51) Int. Cl. H04N 5/92; G11B 27/00

(52) U.S. Cl. 386/52; 386/95

(57) ABSTRACT

A reproduction description system for the purpose of controlling reproduction of plural multimedia data, for reproduction description data directly or indirectly designating reproduction time of each data. In this system, a processed data object generated by applying a set effect to a part of data object corresponding to reproduction target multimedia data, with processed data identification information indicating an attribute for discrimination of processed data, is added to the reproduction description data. Further, first and second data objects are generated from the data object and added to the reproduction description data. Then, reproduction time designation of the first and second data objects in the reproduction description data is changed so as to obtain the same reproduction image as that in a case where the set effect is applied to the data object.

### FIELD OF THE INVENTION

The present invention relates to reproduction of multimedia data such as moving image data, text data and audio data, and more particularly, to a moving image reproduction description method, a moving image reproduction recording apparatus, a moving image reproduction recording storage medium and a moving image reproduction recording program for controlling reproduction of multimedia data by using reproduction description data designating data reproduction time.

### BACKGROUND OF THE INVENTION

In recent years, digital moving images are widely used in a digital video recorder, a DVD and the like, and further, moving images are edited in homes as well as studios by progress of AV and computer devices.

FIG. 17 shows relation among moving image data in a video editing system which performs so-called non-linear editing. “Moving image A” (4701) and “moving image B” (4702) are materials of editing, and “moving image C” (4703) is newly-generated moving image data as a result of editing. In this conventional non-linear editing, a new moving image data is generated by decoding material moving image data if necessary, performing time-directional cutting by cut-in/cut-out and rearrangement, addition of video effect such as a wipe effect between cuts, and further, performing re-encoding if necessary.

On the other hand, also known technique is editing a moving image program without processing moving image data, by describing the order of moving image data reproduction, effects including a video effect and the like by using XML-based reproduction description language e.g. SMIL (Synchronized Multimedia Integration Language), and executing the description data by a reproduction device. In use of SMIL reproduction description data, moving image data and reproduction description data are recorded in different files. The following descriptions are description examples of transitional effect set between two moving images by using SMIL 2.0.

<Description Example 1>
<smil>

<head>

. . .
<transition id=“effect1” type=“barWipe” dur=“1s”/>
. . .

</head>
<body>

<video src=“mov1.mpg” tranOut=“effect1”/>
<video src=“mov2.mpg”/>

</body>

</smil>
<Description Example 2>
<smil>

<head>

. . .

</head>
<body>

<video src=“mov1.mpg”>

<transitionFilter type=“barWipe” dur=“1s”

mode=“out”/>

</video>
<video src=“mov2.mpg”/>

</body>

</smil>

In the descriptions 1 and 2, the same effect is represented by different descriptions.

As shown in the description 1, the “transition” element defines a transition effect in the “head” element. The defined transition effect is referred to by using an ID in a “transIn” attribute or “transOut” attribute for a media object (reproduction target video image data). Note that the transition effect designated by the “transIn” attribute is set on the cut-in side of the media object, while the transition effect designated by the “transOut” attribute is set on the cut-out side of the media object. This designation is called a non-inline designation. When plural transition effects having the same parameter are described by using the transition element, “transitionfilter” element to be described later is used, thereby reproduction description data can be generated such that it has a smaller data amount than that in case of respectively defining the transition effects.

On the other hand, as shown in the <Description Example 2>, the “transitionfilter” element is directly described as a subelement of the media object. Designation of transition effect by the “transitionFilter” element on the cut-in side or the cut-out side is made by a “mode” attribute. If the setting is mode=“in”, the transition effect is on the cut-in side, while if the setting is mode=“out”, the transition effect is on the cut-out side. In the case of description using the “transitionfilter” element, as the transition effect is described as a subelement of the media object, the transition effect applied to the media object can be easily discriminated. Accordingly, high readability of the reproduction description data is attained. Further, upon syntax interpretation, as it is not necessary to previously store the transition effect defined by the “transition” element, the work memory can be reduced. This designation is called an inline designation.

As described above, by using the “transition” element and the “transitionFilter” element, a desired transition effect can be set at a cut-in/cut-out point of arbitrary moving image data. Further, by application of fill=“transition” attribute, a transition effect between two moving image data can be described.

However, in the conventional non-linear editing system, an additional effect such as a video effect is generated in moving image data as a result of editing. Accordingly, it is impossible to delete only the effect later, or to replace the effect with another effect, further, to discriminate the material video image portions from the video image including effect. Further, it is impossible to recognize the type of added moving image effect.

In the editing system using conventional reproduction description data, it is possible to describe a video effect, to exchange the effect with another effect and to delete the effect. However, the execution of effect depends on the specification of reproduction apparatus, and high-level and complicated video effect description and compatible reproduction are impossible by the reproduction description.

Further, the video effect provided in the SMIL is a transition effect, and the application position of video effect is limited to a cut-in/cut-out point of data object, but an effect (reproduction effect) cannot be set in an arbitrary position.

### SUMMARY OF THE INVENTION

The present invention has been made in consideration of the above situation, and has its object to enable addition/deletion of various effects including video effects in a completely reversible manner.

Further, another object of the present invention is to enable addition of effect independent of the specification of reproduction apparatus and to enable addition of high-level effect freely upon editing.

Further, another object of the present invention is, in a moving image reproduction description method using SMIL or the like, to enable description of reproduction effect other than a transition effect, and enable application of video effect to an arbitrary position which is impossible in the conventional art.

According to the above construction, various effects including video effect can be added/deleted in a reversible manner. Further, as the added effect (process data) does not depend on the specification of reproduction apparatus, a high-level effect can be added freely upon editing.

Further, according to the above construction, an applied video effect can be specified.

Further, according to the above construction, a video effect can be applied to an arbitrary position which cannot be described in the conventional SMIL.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a system configuration according to an embodiment of the present invention;

FIG. 2 is an example of effect applied to a range without head and end of clip;

FIG. 3 is an example of setting of effect;

FIG. 4 is a explanatory diagram showing generation of processed clip;

FIG. 5 is a particular example of effect which overlaps two clips;

FIG. 6 is a explanatory diagram showing a status after application of processed clip related attribute;

FIG. 7 is a particular example of effect set at the head of clip;

FIG. 8 is an explanatory diagram showing a status where the effect in FIG. 7 is rendered;

FIG. 9 is a particular example of effect set at the end of clip;

FIG. 10 is a explanatory diagram showing a status where the effect in FIG. 9 is rendered;

FIG. 11 is a particular example of effect applied in a range without head and end of clip;

FIG. 12 is an example of preprocessing for generating a processed clip from the effect in FIG. 11;

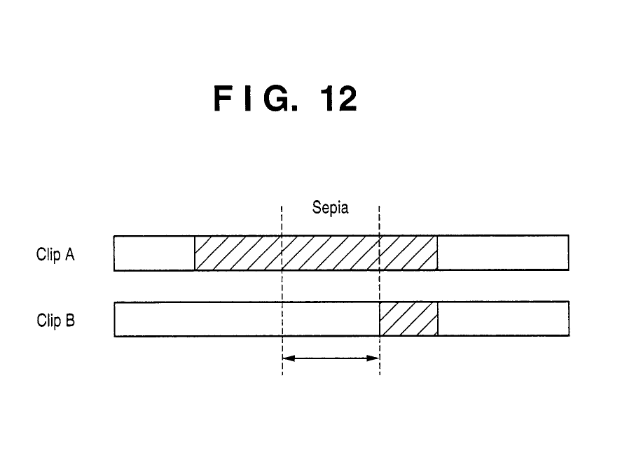

FIG. 13 is a flowchart showing processing to divide the effect applied in the range without head and end of clip;

FIG. 14 is a particular example of processing method for completely reversible effect addition/deletion applied to process of the effect in FIG. 11;

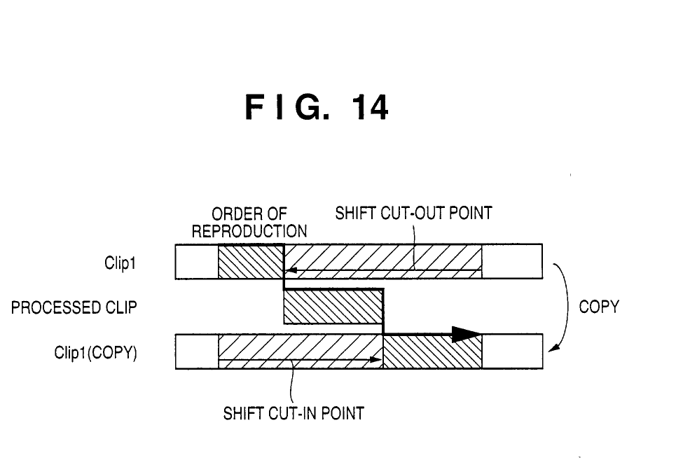

FIG. 15 is a flowchart showing processed clip addition processing according to a third embodiment of the present invention;

FIG. 16 is a flowchart showing processed clip deletion processing according to the embodiment;

FIG. 17 is an example of general non-linear editing; and

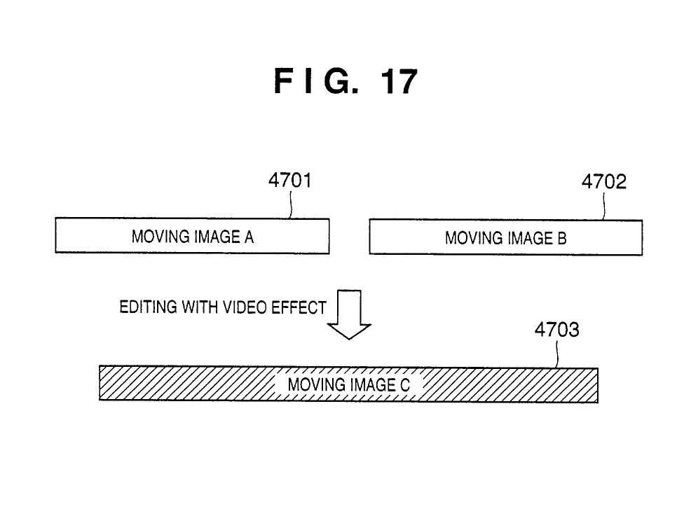

FIG. 18 is an explanatory diagram showing an editing operation in a case where a processed clip includes other portions than a effect.

### DETAILED DESCRIPTION OF THE PREFERRED EMBODIMENTS

Preferred embodiments of the present invention will now be described in detail in accordance with the accompanying drawings.

[First Embodiment]

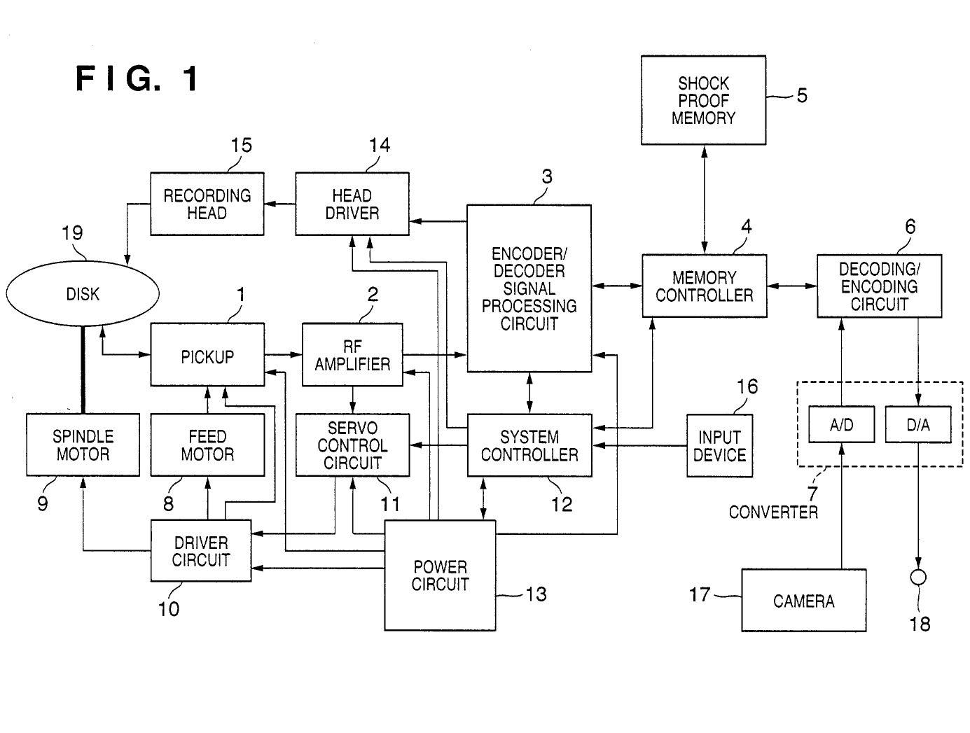

As shown in FIG. 1, a video cam coder device as an information recording reproduction apparatus according to the present embodiment mainly has a disk 19 as a recording medium, a pickup 1 which writes/reads media data such as still image data or audio data into/from the disk 19, an RF amplifier 2 which amplifies a read signal, an encoder/decoder signal processing circuit 3, a shock proof memory 5 for temporarily storing data, a memory controller 4 which controls the shock proof memory 5, a decoding/coding circuit 6, a converter 7 comprising a D/A converter and an A/D converter, a feed motor 8, a spindle motor 9, a driver circuit 10, a servo control circuit 11, a system controller 12 which performs various controls, a power circuit 13, a head driver 14, a recording head 15, an input device 16, a camera 17 as a video/audio input unit, and a terminal 18 as a video/audio output unit. The disk 19 is, e.g., a magneto-optic disk (MO).

In the above construction, operations of the respective elements, from reading of video/audio data from the disk 19 via the pickup 1 to output of the data from the terminal 18, or those from input of video/audio data from the camera 17 to storage of data into disk 19 via the recording head 15 are well known. Accordingly, the explanations thereof will be omitted.

Further, a program for execution of reproduction processing for reproduction description data according to the present embodiment is stored in the system controller 12 and the program operates by utilizing an external memory (not shown). Further, the shock proof memory 5 is utilized as a buffer. Further, although not shown in FIG. 1, the apparatus has a circuit which combines plural video data.

In the construction as above, other various forms, e.g., a construction using a general PC or work station, may be used, however, these forms are not the main subject of the present invention, accordingly, explanations of these elements will be omitted.

Reproduction description data has description of reproduction control information for reproduction of multimedia data such as moving image data, still image data, audio data, text data and the like. The reproduction description data used in the present embodiment is described by e.g. SMIL 2.0 base language. SMIL 2.0 is an XML-base language defined by W3C (world Wide Web Consortium), which can describe reproduction control information of multimedia data. In the reproduction description data using SMIL, reproduction start time may be directly designated by using a “begin” attribute, or may be indirectly designated by using reproduction time lengths of respective files and designating sequential execution of designated file names. In the present embodiment, reproduction description data is described by using a language expanded from SMIL 2.0. The function expansion according to the present embodiment is performed by using name space, however, URI of the name space is omitted. Further, in the present embodiment, “xx:” is used as a prefix of element and attribute in an expanded portion. Note that XML has a tree data structure having plural elements, and each element has 0 or more attribute informations and a node which holds at least an actual reproduction procedure is provided.

A video effect includes a reproduction effect such as temporary sepia-color representation in reproduction video image, and a transition effect applied to an interval between data upon sequential reproduction of two data. The reproduction effect in the present embodiment includes text combining such as caption insertion. In the present embodiment, a description method for reproduction effect will be described. As in the case of the designation method for transition effect by SMIL 2.0, the description method for reproduction effect includes in-line description and non inline description. Next, the details of elements and attributes for designation of reproduction effect will be described.

[1] Effect Element

This element is used for setting a reproduction effect such as temporary sepia-color representation in reproduction video image. The “effect” element can be described only as a subelement of the “head” element, and in this element, attributes as shown in the following Table 1 can be set. The reproduction effect defined as subelement of the “head” element is referred to by using an ID in accordance with “effect” attribute to be described later.

TABLE 1

| Attribute | Comment |
|---|---|
| Id | Designates ID of reproduction effect |
| begin | Designates time from start of clip |
| | reproduction to start of application |
| | of reproduction effect. Default value |
| | is “0s” |
| end | Designates time from start of clip |
| | reproduction to end of application of |
| | reproduction effect. Default value is |
| | time of end of clip reproduction |
| dur | Designates duration of reproduction |
| | effect. |
| type | Designates type of reproduction |
| | effect. |
| subtype | Designates subtype of reproduction |
| | effect. |

[2] Effect Attribute

The “effect” attribute is used for referring to the reproduction effect defined by the above-described “effect” element from a media object. The effect attribute is an attribute of media object.

Note that when plural reproduction effects are described, IDs of the “effect” elements are partitioned with semicolons (;). The following <Description Example 3> shows the usage of the “effect” element and “effect” attribute. In the <Description Example 3>, the effect of sepia-color representation is applied to a section between a point of lapse of 3 seconds and a point of lapse of 10 seconds from the start of reproduction of moving image “samplel.mpg”, and to a section between a point of lapse of 15 seconds and a point of lapse of 28 seconds from the start of reproduction.

<Description Example 3>
<head>

. . .

<xx:effect xx:id=“filter1” xx:begin=“3s” xx:end=“10s”
xx:type=“color” xx:subtype=“sepia”/>
<xx:effect xx:id=“filter2” xx:begin=“15s” xx:end=“28s”
xx:type=“color” xx:subtype=“sepia”/>

. . .

</head>
<body>

<video xx:effect“filter1;filter2”

src=“sample1.mpg”/>

[3] Effectfilter Element Similarly to the above-described “effect” element, “effecfilter” element is used for description of reproduction effect. However, different from the “effect” element, the “effectFilter” element is described as a subelement of media object. Attributes which can be set for the “effectFilter” element are the same as those of the “effect” element. In the following <Description Example 4>, the effect of sepia-color representation is applied to a section between a point of lapse of 3 seconds and a point of lapse of 10 seconds from the start of reproduction of moving image “samplel.mpg”.

<Description Example 4>
<video src=“sample1.mpg”>

<xx:effectFilter xx:begin=“3s” xx: end=“10s”

xx:type=“color” xx:subtype=“sepia”/>
</video>

The above designation of reproduction effect by using the “effect” element and “effect” attribute is non-inline designation. The designation of reproduction effect by using the “effectfilter” element is inline designation.

The above designation method enables description of reproduction effect which is impossible in the standard SMIL 2.0.

[Second Embodiment]

In the first embodiment, the description method for reproduction effect has been described. In the second embodiment, a description method for holding a type of video effect applied to a media object or duration of effect will be described.

In a moving image editing software program or the like, if it is difficult to execute processing to apply a transition effect or reproduction effect in a realtime manner, reproduction is facilitated generally by previously rendering the effect. Moving image data where the transition effect or reproduction effect is produced is called a processed clip.

The SMIL 2.0 system provides no element or attribute to hold a status where a video effect is already made in a part of media object like a processed clip. Further, as there is no parameter regarding time or type of effect, type of effect cannot be displayed upon editing of reproduction description data.

Accordingly, the present embodiment provides a method for holding parameter(s) of video effect applied to a part of media object. As in the case of the first embodiment, SMIL 2.0 is expanded to realize this function.

[4] EffecTime Element

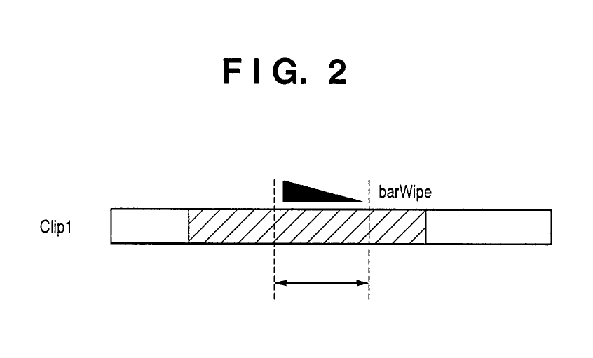

In a case where a previously-designated effect is rendered, an “effectTime” element is used for describing the range of rendering. If a rendering length is shorter than a clip length, a clip reproduction period and a rendered part do not correspond with each other (FIG. 2). In this case, the “effectTime” element holds the time of the rendered part. Table 2 shows attributes which can be set for the “effectTime” element. <Description Example 5> shows an example of description. In this example, effect application time section information includes effect parameter information.

TABLE 2

| Attribute | Comment |
|---|---|
| begin | Designates a period from start of clip |
| | reproduction to start of rendered part. |
| | Default is “0s” |
| end | Designates a period from start of clip |
| | reproduction to end of rendered part. |
| | Default is clip reproduction end time. |
| dur | Designates a duration of rendered part. |
| effectType | Holds type of rendered effect. |
| type | Designates type of rendered effect. |
| subtype | Designates subtype of rendered effect. |

<Description Example 5>
<video src=“clip1.mpg”>

<xx:effectTime xx:effectType=“transition”

xx:begin=“2s” xx:type=“barWipe”/>
</video>

In the <Description Example 5>, the rendered part is a part from a point of lapse of 2 seconds to a point of laps of 4 seconds from the start of reproduction of moving image clip1.mpg. The rendered part is a transition effect, and the type of transition effect is “barWipe”. In this manner, the type of effect of the rendered part is designated by the “effectType” attribute. Table 3 shows attribute values of the “effetType” attribute.

TABLE 3

| Value | Comment |
|---|---|
| transition | Transition effect |
| filter | Reproduction effect |
| text | Text combining |
| others | others |

The video effects in the present embodiment are discriminated by parameters which fall in three-level hierarchical structure having a broad category, an intermediate category, and a fine category.

The broad category is a brief classification of effect designated by the “effetType” attribute. For example, in the present embodiment, Table 3 shows broad categories “transition effect (transition)”, “reproduction effect (filter)”, “text combining (text)” and “others (others)”. The “effectType” attribute is used for holding whether or not the applied effect is a transition effect, the reproduction effect or other effect.

The intermediate category includes effect discriminative names designated by the “type” attribute in the present embodiment. The fine category includes effect application directions and operations designated by the “subtype” attribute in the present embodiment.

If the “effectType” is “transition”, information corresponding to the “type” attribute provided in the SMIL 2.0 transition element such as “barWipe” is held by using the “type” attribute, and information corresponding to the “subtype” attribute provided in the SMIL 2.0 “transition” element such as “toLeft” is held by using the “subtype” attribute.

If the “effectType” is “filter”, the type of reproduction effect such as “mosaic” is held by using the “type” attribute, and an effect application parameter such as “16×16” indicating the mosaic size is held by using the “subtype” attribute.

If the “effectType” is “text”, a combined character string is stored in the “type”, and a document format is held in the “subtype”. In this case, the text data may be used as search target meta data upon search for reproduction description data.

Regarding section information on a section where the video effect is applied, a section start time is described by the “begin” attribute, a section end time, by the “end” attribute, and section duration is described by the “dur” attribute.

In this manner, the parameter of video effect is described by using the “effectType” element and added as a subelement of target media object, thereby the type or application position of video effect applied to the media object can be held.

[Third Embodiment]

In the first and second embodiments, the video effect description method and video effect parameter holding method have been described. In the third embodiment, processed clip addition/deletion method will be described as adding or deleting a processed clip generated by rendering a part of media object. Note that as long as video data where a desired video effect is applied is prepared as a processed clip, the reproduction apparatus side merely reproduces this processed clip. Thus a desired video effect can be produced independently of editing performance of the reproduction apparatus.

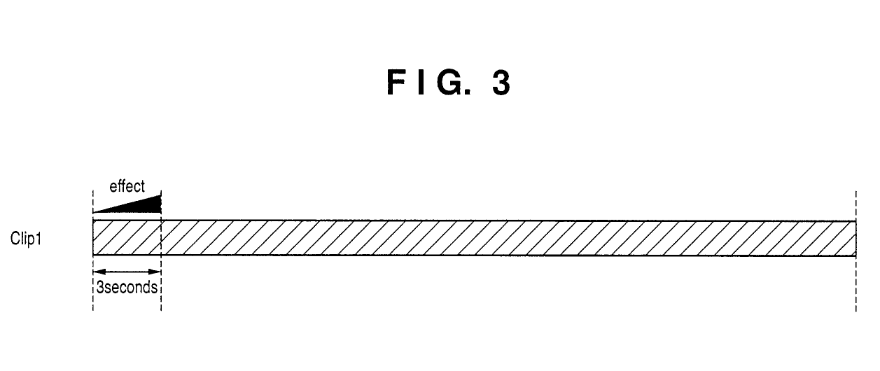

First, FIG. 3 shows an example where an effect is set in moving image data Clip1. The status of FIG. 3 is described in reproduction description data by using the description method of the present embodiment as shown in e.g. the following <Description Example 6>. In this case, a sepia-color effect is applied to 3 seconds at the head of the moving image data Clip1.

<Description Example 6>

<video src=“clip1.mpg”>

<xx:effectFilter xx:type=“filter”

xx:subtype=“sepia” xx:dur=“3s”/>
</video>

In this status, the setting of the effect can be cancelled by deleting the “filter” element as a subelement of the “video” element.

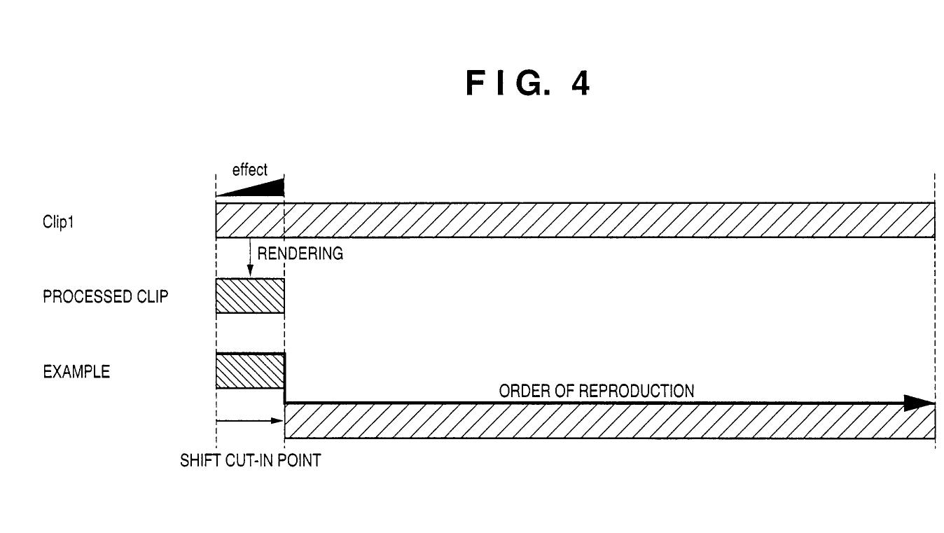

FIG. 4 shows a result of rendering the effect part in the example of FIG. 3. As shown in FIG. 4, if the effect applied to the head of the moving image data is rendered, first, a processed clip is generated by rendering the effect part and then a cut-in point of the Clip1 is shifted by the reproduction duration of the processed clip. The following <Description Example 7> shows a particular example of description of the execution example of FIG. 4 without processed clip by the description method according to the present embodiment.

<Description Example 7>

<video src=“rclip1.mpg” . . . />

<video src=“clip1.mpg” clipBegin=“3s” . . . />

In the reproduction description data in the <Description Example 7>, the first line indicates the processed clip, and the second line, a part reproduced subsequently to the processed clip. In the second line, the newly added “clipBegin” attribute is used for description of the cut-in point. This description enables reproduction of moving image including a rendered part. However, as identification information of processed clip and cut-in point shift amount are not held, the processed clip cannot be removed, i.e., the status cannot be returned to that of FIG. 3. The effect applied there cannot be removed.

Accordingly, information for identification of rendered processed clip, parameters of type and time of rendered effect, information to hold shit amount of cut-in or cut-out point by addition of processed clip, are added to the description.

[5] Systeminsert Attribute The “systeminsert” attribute is used for discrimination as to whether or not a subject clip is a clip to be removed. This attribute has a value “true” or “false”. If the value is “true”, the clip is a processed clip. If the effect of the processed clip is to be held, it is held by using the “effectTime” element ([4]). A “systeminsert” attribute set in other element than the media object is ignored.

[6] HeadShift Attribute and TailShift Attribute

The “headShift” attribute is used for holding the cut-in point shift amount by generation/insertion of processed clip. Similarly, the “tailShift” attribute is used for holding the cut-out point shift amount.

Finally, the “effectTime” element is used for description of the processed clip, thus the rendered effect parameter is held.

In this manner, the processed clip addition/deletion processing can be performed in a completely reversible manner by using these elements and attributes. The following <Description Example 8> shows the result of application of the above-described “systeminsert” attribute, the “headShift” attribute and the “effectTime” element to the standard SMIL in the

<Description Example 7>.
<Description Example 8>
<video xx:systemInsert=“true” src=“rclip1.mpg” . . . >

<xx:effectTime xx:effectType=“filter” xx:type=“color”

xx:subtype=“sepia”/>
</video>
<video xx:headShift=“3s” src=“clip1.mpg”
clipBegin=“3s”/>

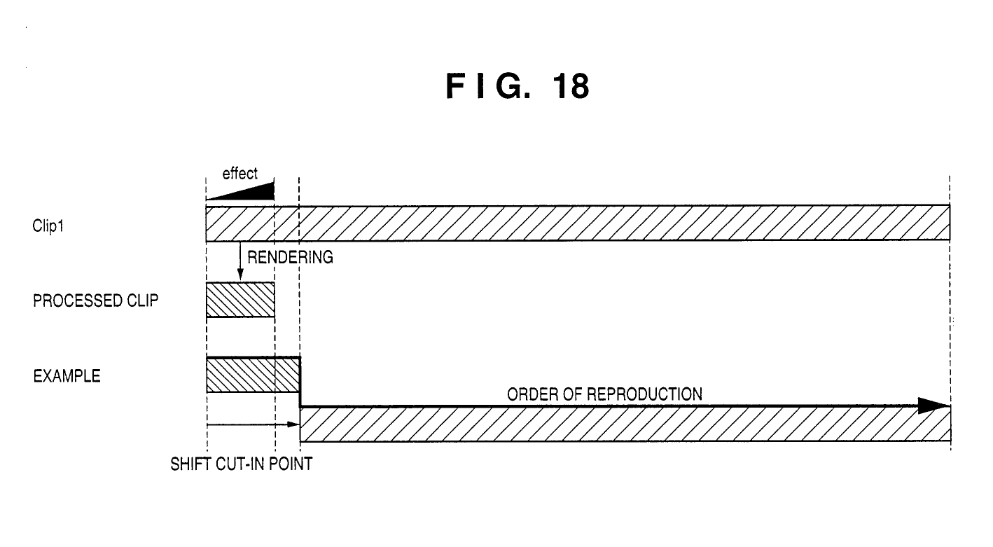

Further, as shown in FIG. 18, a processed clip may include other part than an effect part. In the case where a processed clip reproduction duration is different from an effect application duration, the following description is made by using the “effectTime” element.

<Description Example 9>
<video xx:systemInsert=“true” src=“rclip1.mpg” . . . >

<xx:effectTime xx:effectType=“filter” xx:dur=“3s”

xx:type=“color” xx:subtype=“sepia”/>
</video>
<video xx:headShift=“4s” src=“clip1.mpg” clipBegin=“4s”
. . . />

In this description, as the processed clip start time and the effect start time coincide with each other, description of effect start time is omitted, however, description xx:begin=“0s” may be added.

By the above expansion, the functions which cannot be realized in the standard SMIL can be added, and an effect can be added/deleted in a completely reversible manner.

Next, a processed clip addition method and reproduction description data description method after generation of processed clip will be described. Hereinbelow, a clip 1 (Clip1) is handled as a part of moving image file “mov1. mpg”, a clip 2 (Clip2), a part of moving image file “mov2.mpg”, and a processed clip, a moving image file “rclip1.mpg”. Further, clips Clip1 and Clip2 are described as follows:

Clip1: <video src=“mov1.mpg” clipBegin=“5s”

clipEnd=“23s”/>

Clip2: <video src=“mov2.mpg” clipBegin=“3s”

clipEnd=“52s”/>

·Case 1: processing on effect set overlapped with

clips

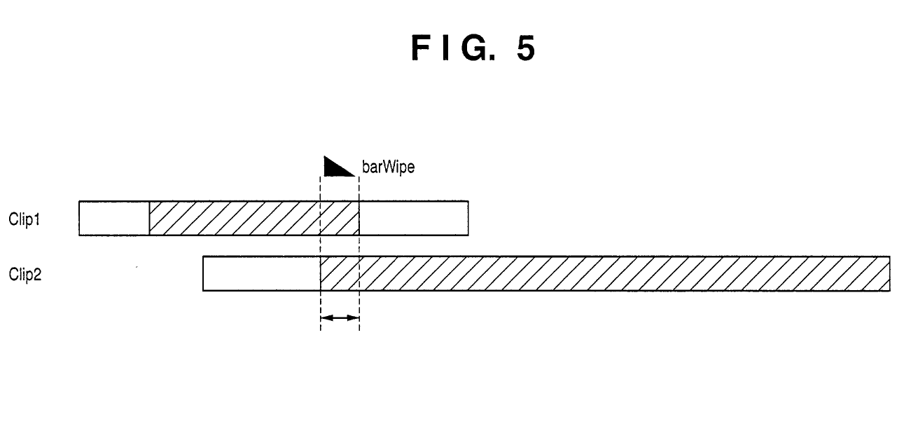

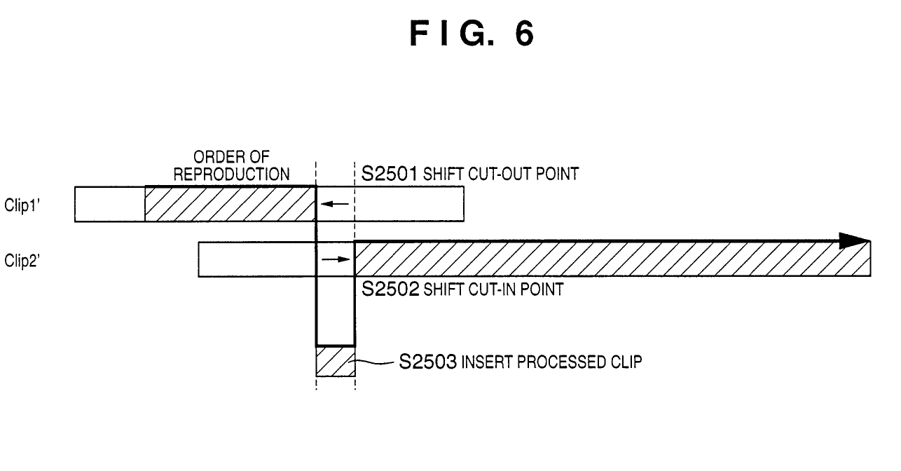

For example, as shown in FIG. 5, if a transition effect is applied between the clips Clip1 and Clip2, this processing is performed. Assuming that the application time of the transition effect is 2 seconds, three processings as shown in FIG. 6 are performed.

In the present embodiment, the processing is performed at step S2501, then at step S2502 and at step S2503. First, at step S2501, the cut-out point of the Clip1 is shifted, and the cut-out point shift amount is subtracted from the reproduction duration of the Clip1. The Clip1 where the cut-out point has been shifted becomes Clip1′. Next, at step S2502, the cut-in point of the Clip2 is shifted, and the cut-in point shift amount is subtracted from the reproduction duration of the Clip2. The Clip2 where the cut-in point has been shifted becomes Clip2′. Finally, at step S2503, the processed clip is inserted. Note that the order of execution of steps S2501 to S2503 is not fixed but may be in any order. The following <Description Example 10> shows an example of description in FIG. 6.

<Description Example 10>
<video src=“mov1.mpg” clipBegin=“5s” clipEnd=“21s”
xx:tailShift=“2s”/>
<video src=“rclip1.mpg” xx:systemInsert=“true”>

<xx:effecTime xx:effectType=“transition”

xx:type=“barWipe”/>
</video>
<video src=“mov2.mpg” clipBegin=“5s” clipEnd=“52s”
xx:headShift=“2s”/>

Case 2: processing on effect set at head of clip

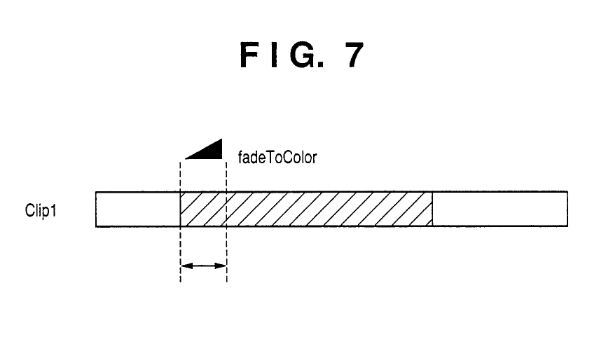

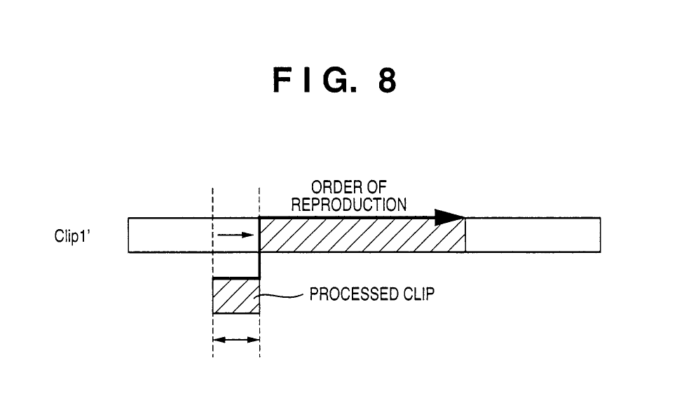

For example, as shown in FIG. 7, if a transition effect is applied at the head of the Clip1, this processing is performed. Assuming that the application time of the transition effect is 2 seconds, the cut-in point is shifted and the processed clip is inserted as in the case of the case 1. The result of processed clip insertion is as shown in FIG. 8. The following <Description Example 11> shows an example of description in FIG. 8.

<Description Example 11>
<video src=“rclip1.mpg” xx:systemInsert=“true”>

<xx:effectTime xx:effectType=“transition”
xx:type=“fadeToColor”/>
</video>
<video src=“mov1.mpg” clipBegin=“7s” clipEnd=“23s”
xx:headShift=“2s”/>

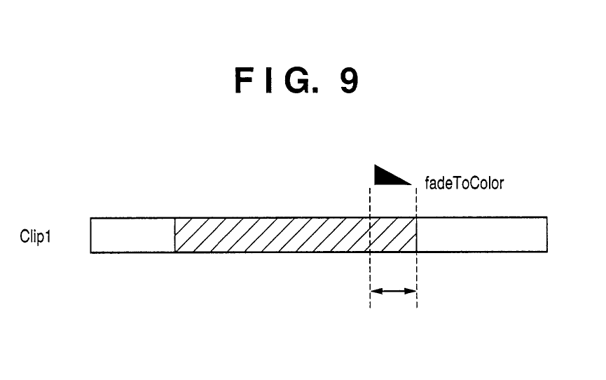

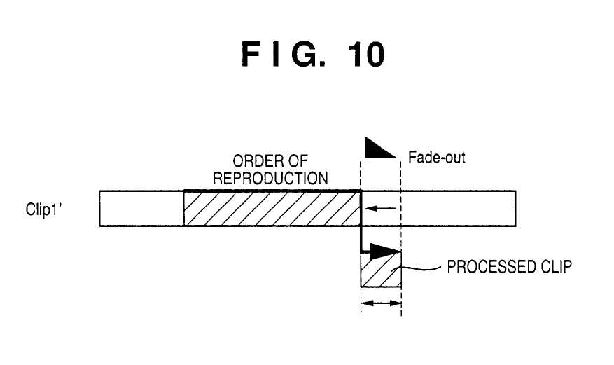

Case 3: processing on effect set at end of clip For example, as shown in FIG. 9, if a transition effect is applied at the end of the Clip1, this processing is performed. Assuming that the application time of the transition effect is 2 seconds, the cut-out point is shifted and the processed clip is inserted as in the case of the case 1. The result of processed clip insertion is as shown in FIG. 10. The following <Description Example 12> shows an example of description in FIG. 10.

<Description Example 12>
<video src=“mov1.mpg” clipBegin=“7s” clipEnd=“23s”
xx:tailShift=“2s”/>
<video src=“rclip1.mpg” xx:systemInsert=“true”>

<xx:effectTime xx:effectType=“transition”

xx:type=“fadeOut”/>
</video>

Case 4: processing on effect set in range without head/end of clip

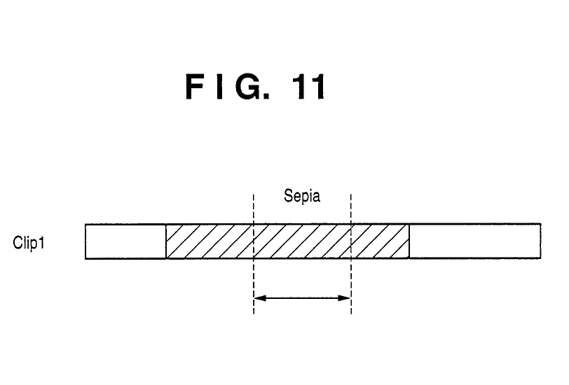

For example, in FIG. 11, this processing is performed. In this case, two types of processing may be performed.

The first method is dividing the target clip at an effect start point or effect end point. After the division, the processing of the above case 2 or 3 is performed on the effect-applied clip, thereby the processed clip can be inserted. The clip dividing operation according to the present embodiment is division of reproduction designation on reproduction description data. For example, in the description <video src=“mov1.mpg” clipBegin=“5s” clipEnd=“23s”>, if the moving image data “mov1.mpg” is divided in a position of lapse 5 seconds from the start of reproduction, the description is:

<video src=“mov1.mpg” clipBegin=“5s” clipEnd=“10s”>

<video src=“mov1.mpg” clipBegin=“10s” clipEnd=“23s”>

As the processing completely divides the clip, the initial description cannot be restored although the result of reproduction can be the same as that by the initial description. However, as processed-clip related processing can be made by the processings in the above cases 1 to 3, the processing can be easily realized.

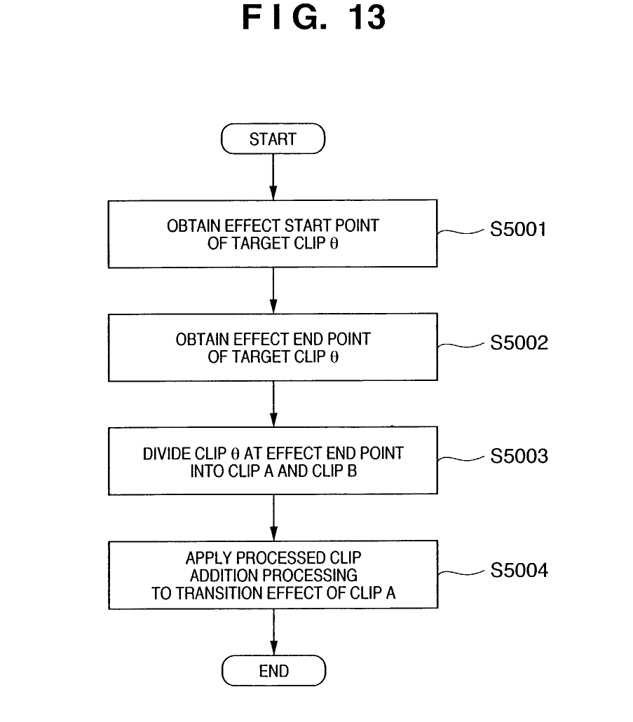

FIG. 13 is a flowchart showing the processing to divide the target clip at an effect end point.

At step S5001, an effect start point of reproduction effect is obtained for a target clip θ and its corresponding media object. Next, at step S5002, an effect end point of the reproduction effect applied to the clip θ is obtained. At step S5003, the clip θ is divided into clip A and clip B at the effect end point obtained at step S5002. By the processing at step S5002, the reproduction effect is applied to the end of the clip A. Finally, at step S5004, a processed clip is generated by the same method as that of the case 3.

By the above processing, an effect applied to a position without head or end of clip can be processed.

In the example of FIG. 13, the clip is divided at the effect end point, however, it may be arranged such that the clip is divided at the effect start point and a processed clip is generated at step S5004 by the same method as that of the case 2. Further, if the clip is divided at the effect start point, the processing at step S5002 may be omitted.

The second method is generating a copy of original clip and inserting a processed clip between the original clip and the copy clip. In this method, the processing is complicated but effect addition/deletion can be made in a completely reversible manner. Note that the clip copying operation according to the present embodiment is duplication of reproduction designation on reproduction description data. For example, in a description <video src=“mov1.mpg” clipBegin=“5s” cipEnd=“23s”/>, if a copy of the moving image data “mov1.mpg” is made, a copy of reproduction designation having the same parameters is made as follows.

<video src=“mov1.mpg” clipBegin=“5s” clipEnd=“23s”/>

<video id=“copied” src=“mov1.mpg” clipBegin=“5s” clipEnd=“23s”/>

Hereinbelow, the details of addition and deletion will be described.

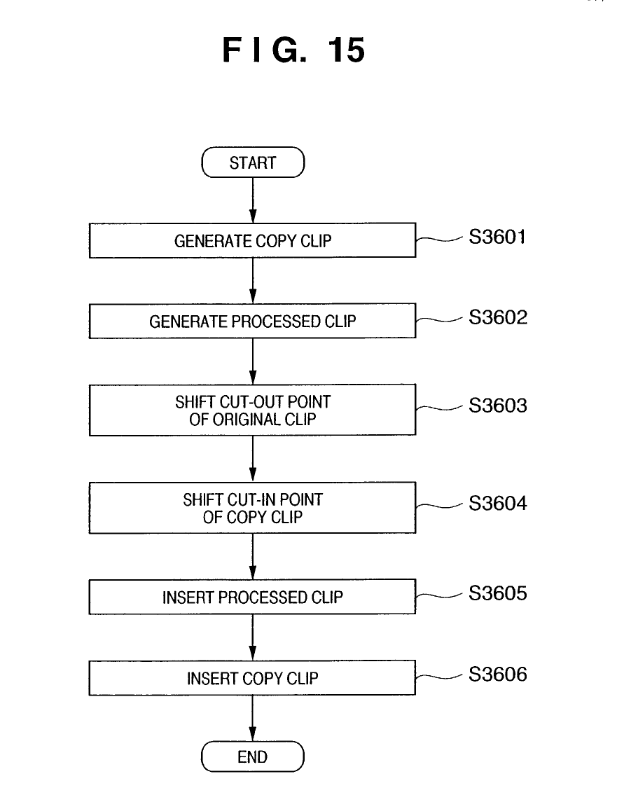

FIG. 15 is a flowchart showing the processed clip addition processing according to the above second method. First, at step S3601, a copy clip of the target clip is made. The copy clip is a clip having the same attribute and subelement values as those of the original clip except an “id” attribute of the copy clip and its subelement. Next, at step S3602, a processed clip is generated. At step S3603, the cut-out point of the original clip is shifted to reproduction start time of the processed clip. After the shift of cut-out point, the cut-out point shift amount is subtracted from the reproduction duration of the original clip. At step S3604, the cut-in point of the copy clip is shifted to reproduction end time of the processed clip. After the shift of cut-in point, the cut-in shift amount is subtracted from the reproduction duration of the copy clip. Finally, at steps S3605 and S3606, the processed clip and the copy clip are added to the reproduction description data.

FIG. 11 shows the result of the above processing. In the present embodiment, the copy clip is arranged behind the original clip, however, it may be arranged such that the copy clip is provided ahead of the original clip and the copy clip is provided between the copy clip and the original clip.

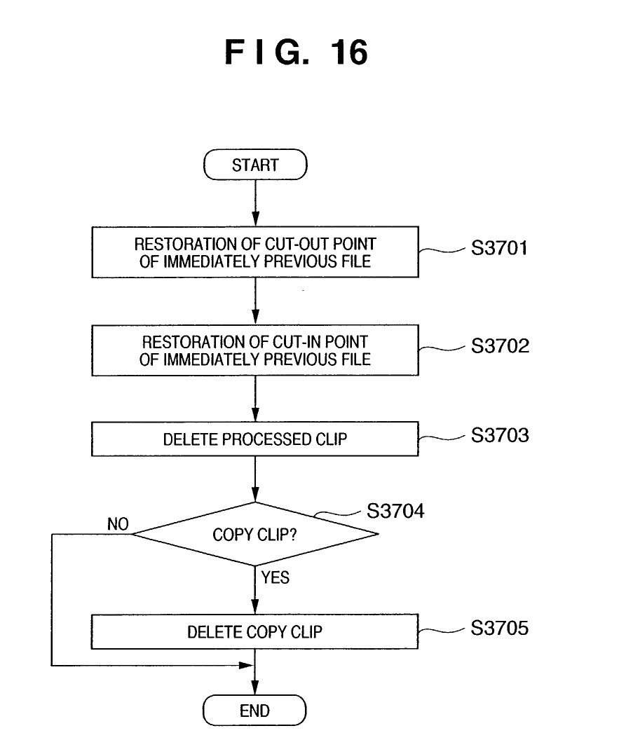

FIG. 16 is a flowchart showing the processed clip deletion processing. First, at step S3701, it is examined whether or not the tailShift attribute exists in a clip α immediately preceding the processed clip to be deleted. If the “tailShift” attribute exists, the “tailShift” attribute value is added to the “clipEnd” and “dur” attribute values of the clip α. By this processing, the cut-out point shifted in the above second method can be restored. Next, at step S3702, it is examined whether or not the “headShift” attribute exists in a clip β immediately following the processed clip to be deleted. If the “headShift” attribute exists, the “headShift” value is subtracted from the “clipBegin” and “dur” attribute values of the clip A. By this processing, the cut-in point shifted in the above second method can be restored. Next, at step S3703, the processed clip is deleted.

At step S3704, the clip α is compared with the clip β, and if all the parameters correspond with each other, it is determined that the clip β is a copy clip. The process proceeds to step S3705 at which the clip β is deleted.

By the above deletion processing, the processed clip added by the above first or second method can be deleted and the status immediately before the rendering can be restored. Note that if the processed clip is inserted by the first method, the processing at steps S3704 and S3705 may be omitted.

By the processed clip deletion/deletion method, it is possible to add or delete an effect in any position of clip in a completely reversible manner.

As described above, the information recording apparatus of the present embodiment enables various effects including video effect can be added and deleted in a completely reversible manner. Further, as the added effect does not depend on the specification of reproduction apparatus, a high-level effect can be freely added upon editing.

Further, an applied video effect can be specified by adding effect application time section information to a processed data object, adding parameter(s) of video effect to the effect application time section information and holding the object.

Further, in the SMIL-base moving image reproduction description system, as a reproduction effect other than a transition effect is described in reproduction description data, application of video effect to an arbitrary position, which cannot be made in the conventional SMIL, can be realized.

Note that the object of the present invention can be also achieved by providing a storage medium holding software program code for performing the functions according to the above-described embodiments to a system or an apparatus, reading the program code with a computer (e.g., CPU, MPU) of the system or apparatus from the storage medium, then executing the program.

In this case, the program code read from the storage medium itself realizes the functions according to the above embodiments, and the storage medium holding the program code constitutes the invention.

Further, the storage medium, such as a floppy disk, a hard disk, an optical disk, a magneto-optical disk, a CD-ROM, a CD-R, a DVD, a magnetic tape, a non-volatile type memory card, and a ROM can be used for providing the program code.

Furthermore, besides aforesaid functions according to the above embodiments are realized by executing the program code which is read by a computer, the present invention includes a case where an OS (operating system) or the like working on the computer performs a part or entire actual processing in accordance with designations of the program code and realizes functions according to the above embodiments.

Furthermore, the present invention also includes a case where, after the program code is written in a function expansion card which is inserted into the computer or in a memory provided in a function expansion unit which is connected to the computer, a CPU or the like contained in the function expansion card or unit performs a part or entire actual processing in accordance with designations of the program code and realizes the functions according to the above embodiments.

As described above, according to the present invention, various effects including video effects can be added or deleted in a completely reversible manner.

Further, according to the present invention, in a general moving image reproduction description system in a language such as SMIL, as a reproduction effect other than a transition effect can be described in reproduction description data, application of video effect to an arbitrary position, which cannot be made by the conventional art, can be realized.

Further, as a parameter of video effect made in moving image data is held, discrimination can be made between a material part and an effect applied part.

Further, in the above-described embodiments, reproduction description data for moving image reproduction has been described, however, the present invention is also applicable to reproduction description data for audio reproduction by audio data. In this case, a video effect is replaced with a sound effect such as a reverb effect. Further, reproduction description data to which a video effect or sound effect is applied can be provided for reproduction of video-audio composite signal such as data obtained by a video camera.

As many apparently widely different embodiments of the present invention can be made without departing from the spirit and scope thereof, it is to be understood that the invention is not limited to the specific embodiments thereof except as defined in the appended claims.

What is claimed is:

1. A moving image reproduction description method for reproduction description data directly or indirectly designating reproduction time of multimedia data such as plural moving image data, still image data, text data and audio data, for the purpose of controlling reproduction of multimedia data, comprising the steps of:
adding a processed data object generated by applying a set effect to a part of data object corresponding to reproduction target multimedia data, with processed data identification information indicating an attribute for discrimination of processed data, to said reproduction description data;
generating first and second data objects, at least one of the data objects including reproduction time information of said processed data object, from said data object, and adding the data objects to said reproduction description data; and
changing reproduction time designation of said first and second data objects in said reproduction description data so as to obtain the same reproduction image as that in a case where said set effect is applied to said data object.

2. The moving image reproduction description method according to claim 1, wherein at said generating step, said first and second data objects are generated by dividing said data object in a reproduction start position or reproduction end position of said processed data object.

3. The moving image reproduction description method according to claim 1, wherein at said generating step, said first and second data objects are generated by copying said data object.

4. The moving image reproduction description method according to claim 1, wherein an application range of said effect is a head of said data object.

5. The moving image reproduction description method according to claim 1, wherein an application range of said effect is an end of said data object.

6. The moving image reproduction description method according to claim 1, wherein an application range of said effect is in a range without head or end of said data object.

7. The moving image reproduction description method according to claim 1, further comprising the step of adding effect application time section information, including an effect start point, an effect end point or an effect duration in said processed data object, to said processed data object in said reproduction description data.

8. The moving image reproduction description method according to claim 7, wherein said effect application time section information includes one or more effect parameter information.

9. The moving image reproduction description method according to claim 8, wherein said effect parameter information has a hierarchical structure.

10. The moving image reproduction description method according to claim 9, wherein at least one level of said effect parameter information indicates an effect category.

11. The moving image reproduction description method according to claim 10, wherein said effect category includes a transition effect.

12. The moving image reproduction description method according to claim 10, wherein said effect category includes reproduction effect.

13. The moving image reproduction description method according to claim 10, wherein said effect category includes text combining.

14. The moving image reproduction description method according to claim 10, wherein said effect category includes image combining.

15. The moving image reproduction description method according to claim 9, wherein at least one level of said effect parameter information indicates an effect name.

16. The moving image reproduction description method according to claim 15, wherein said effect name indicates a type of transition effect.

17. The moving image reproduction description method according to claim 15, wherein said effect name indicates a type of reproduction effect.

18. The moving image reproduction description method according to claim 15, wherein said effect name indicates a text character string to be combined.

19. The moving image reproduction description method according to claim 18, wherein said text character string can be utilized for file search in reproduction description data.

20. The moving image reproduction description method according to claim 15, wherein said effect name is information on combined image.

21. The moving image reproduction description method according to claim 9, wherein at least one level of said effect parameter information indicates an effect content.

22. The moving image reproduction description method according to claim 21, wherein said effect content is a subtype of transition effect.

23. The moving image reproduction description method according to claim 21, wherein said effect content is a text format.

24. The moving image reproduction description method according to claim 1, at said step of changing reproduction time designation, restoration information to restore reproduction time designation previous to changing is added to said first and second data objects where the reproduction time designation is changed.

25. The moving image reproduction description method according to claim 24, wherein said restoration information indicates a shift amount of reproduction start time or reproduction end time in said first and second data objects.

26. The moving image reproduction description method according to claim 1, wherein at said step of changing reproduction time designation, the reproduction time designation of said first and second data objects is changed so as to obtain correspondence between reproduction end time of said first data object and reproduction start time of said processed data object, and between the reproduction end time of said data object and the reproduction start time of said second data object.

27. The moving image reproduction description method according to claim 1, wherein at said step of changing reproduction time designation, the reproduction time designation of said first and second data objects is changed so as to obtain correspondence between reproduction end time of said second data object and reproduction start time of said processed data object, and between the reproduction end time of said data object and the reproduction start time of said first data object.

28. The moving image reproduction description method according to claim 1, wherein said reproduction description data has a tree data structure having plural elements and each element of said tree data structure has 0 or more attribute information, and wherein at least a node holding an actual reproduction procedure is provided.

29. The moving image reproduction description method according to claim 1, wherein said reproduction description data is described in XML.

30. The moving image reproduction description method according to claim 1, wherein said reproduction description data is described in SMIL.

31. The moving image reproduction description method according to claim 3, further comprising the step of: when said processed data object is deleted from said reproduction description data, if said first and second data objects include information for restoring time designation, restoring reproduction time designation of said first and second data objects and deleting the information for restoring time designation; and if said first and second data objects where the reproduction time designation is restored are in original and copy objects, deleting said second data object.

32. A moving image reproduction description method for the purpose of controlling reproduction of multimedia data, comprising the steps of:
adding a processed data object generated by applying a set effect to a part of data object corresponding to a reproduction target multimedia data to reproduction description data; and
adding effect application time section information, including any one of an effect start point, an effect end point and an effect duration in said processed data object, to said processed data object in said reproduction description data.

33. The moving image reproduction description method according to claim 32, wherein said effect application time section information includes effect parameter information.

34. The moving image reproduction description method according to claim 33, wherein said effect parameter information has a hierarchical structure.

35. The moving image reproduction description method according to claim 34, wherein at least one level of said effect parameter information indicates an effect category.

36. The moving image reproduction description method according to claim 35, wherein said effect category includes a transition effect.

37. The moving image reproduction description method according to claim 35, wherein said effect category includes a reproduction effect.

38. The moving image reproduction description method according to claim 35, wherein said effect category includes text combining.

39. The moving image reproduction description method according to claim 35, wherein said effect category includes image combining.

40. The moving image reproduction description method according to claim 34, wherein at least one level of said effect parameter information indicates an effect name.

41. The moving image reproduction description method according to claim 40, wherein said effect name indicates a type of transition effect.

42. The moving image reproduction description method according to claim 40, wherein said effect name indicates a type of reproduction effect.

43. The moving image reproduction description method according to claim 40, wherein said effect name indicates a text character string to be combined.

44. The moving image reproduction description method according to claim 43, wherein said text character string can be utilized for file search in reproduction description data.

45. The moving image reproduction description method according to claim 40, wherein said effect name is information on combined image.

46. The moving image reproduction description method according to claim 34, wherein at least one level of said effect parameter information indicates an effect content.

47. The moving image reproduction description method according to claim 46, wherein said effect content is a subtype of transition effect.

48. The moving image reproduction description method according to claim 46, wherein said effect content is a text format.

49. The moving image reproduction description method according to claim 32, wherein said reproduction description data has a tree data structure having plural elements and each element of said tree data structure has 0 or more attribute information, and wherein at least a node holding an actual reproduction procedure is provided.

50. The moving image reproduction description method according to claim 32, wherein said reproduction description data is described in XML.

51. The moving image reproduction description method according to claim 32, wherein said reproduction description data is described in SMIL.

52. A moving image reproduction description method for the purpose of controlling reproduction of multimedia data, comprising the steps of:
describing a data object corresponding to reproduction target multimedia data; and
adding a video effect to be applied to said data object to said reproduction description data,
wherein said reproduction description data has a tree data structure having plural elements and each element of said tree data structure has 0 or more attribute information, and wherein at least a node holding an actual reproduction procedure is provided.

53. The moving image reproduction description method according to claim 52, wherein said reproduction description data is described in XML.

54. The moving image reproduction description method according to claim 52, wherein said reproduction description data is described in SMIL.

55. The moving image reproduction description method according to claim 52, wherein the video effect is described in a node different from the node holding the actual reproduction procedure.

56. The moving image reproduction description method according to claim 55, wherein description of said video effect is made by defining a video effect parameter by describing said video effect as a subelement of an SMIL head element, and wherein a reproduction effect is designated by referring to an id attribute of the subelement from a media object.

57. The moving image reproduction description method according to claim 52, wherein description of said video effect is made by designation of a video effect parameter by using a subelement of an SMIL media object.

58. The moving image reproduction description method according to claim 56, wherein said video effect parameter is an effect type.

59. The moving image reproduction description method according to claim 56, wherein said video effect parameter includes any one of an effect start point, an effect end point and an effect duration.

60. The moving image reproduction description method according to claim 57, wherein said video effect parameter is an effect type.

61. The moving image reproduction description method according to claim 57, wherein said video effect parameter includes any one of an effect start point, an effect end point and an effect duration.

62. A moving image reproduction recording apparatus comprising:
recording means for recording moving image data and reproduction description data by the moving image reproduction description method according to claim 1; and
reproduction means for reproducing said moving image data in accordance with the reproduction description data recorded by said recording means.

63. A storage medium holding a control program for realizing the moving image reproduction description method according to claim 1 by a computer.

64. A control program for realizing the moving image reproduction description method according to claim 1 by a computer.
